(19) United States
(12) Patent Application Publication
(10) Pub. No.: US 2020/0156224 A1
(43) Pub. Date: May 21, 2020

(54) WIRE REEL FOR REBAR TYING MACHINE AND METHOD OF MANUFACTURING THE SAME

(71) Applicant: MAKITA CORPORATION, Anjo-shi, Aichi (JP)

(72) Inventor: Mitsuo SUENAGA, Anjo-shi (JP)

(73) Assignee: MAKITA CORPORATION, Anjo-shi, Aichi (JP)

(21) Appl. No.: 16/621,277

(22) PCT Filed: Apr. 6, 2018
(86) PCT No.: PCT/JP2018/014766

§ 371 Date: Dec. 11, 2019

(30) Foreign Application Priority Data
Jun. 21, 2017 (JP) 2017-121694

(51) Int. Cl. B25B 25/00; B65B 13/18; E04G 21/12

(52) U.S. Cl. CPC B25B 25/00; E04G 21/123; B65B 13/18

(57) ABSTRACT

A wire reel for rebar tying machine including a reel and a wire wound therearound and an engagement portion at which an earlier-wound part of the wire may be engaged with a later-wound part of the wire by the later-wound part of the wire sinking below the earlier-wound part of the wire. A manufacturing method of a wire reel for rebar tying machine includes: fixing one end of a wire to a reel; winding the wire around the reel by feeding the wire while rotating the reel; and stopping the feeding of the wire while rotating the reel to cause a later-wound part of the wire to sink below an earlier-wound part of the wire such that the later-wound part of the wire engages with the earlier-wound part of the wire.

### TECHNICAL FIELD

The technique disclosed herein relates to a wire reel for a rebar tying machine and a method of manufacturing a wire reel for a rebar tying machine.

### BACKGROUND ART

Japanese Patent Application Publication No. H11-159145 describes a wire reel for a rebar tying machine that is provided with a reel and a wire wound around the reel. In this wire reel, the wire is wound after a viscous coating agent has been applied thereto, by which the wire wound around the reel is prevented from becoming loose.

### SUMMARY OF INVENTION

When the above-described wire reel is used in a rebar tying machine, the coating agent on the wire might be chipped off at a wire feeding mechanism that feeds out the wire from the wire reel and/or a wire guide mechanism that guides the wire, for example, and the chipped pieces of the coating agent might build up or enter inside the rebar tying machine. A technique that can prevent a wire wound on a reel from becoming loose without application of a coating agent to the wire is in demand.

The present disclosure discloses a wire reel for a rebar tying machine. The wire reel may comprise a reel and a wire wound around the reel. The wire may comprise an engagement portion. At the engagement portion, an earlier-wound part of the wire may be engaged with a later-wound part of the wire by the later-wound part of the wire sinking below the earlier-wound part of the wire.

According to the above configuration, the later-wound part of the wire is engaged with the earlier-wound part of the wire at the engagement portion, which prohibits the later-wound part of the wire from moving in a direction separating away from the reel. Thus, the wire wound around the reel can be prevented from becoming loose. According to the above configuration, the wire wound around the reel can be prevented from becoming loose without application of a coating agent on the wire.

The disclosure herein further discloses a method of manufacturing a wire reel for a rebar tying machine that includes a reel and a wire wound around the reel. The method may comprise steps of: fixing one end of the wire to the reel; winding the wire around the reel by feeding the wire while rotating the reel; and stopping the feeding of the wire while rotating the reel to cause a later-wound part of the wire to sink below an earlier-wound part of the wire such that the later-wound part of the wire engages with the earlier-wound part of the wire.

According to the above manufacturing method, the wire is wound around the reel by feeding the wire while rotating the reel, and then the feeding of the wire is stopped while rotating the reel to apply a high tensile force on the wire. Due to this, the later-wound part of the wire is caused to sink below the earlier-wound part of the wire such that the later-wound part of the wire can engage with the earlier-wound part of the wire. According to the above manufacturing method, the wire wound around the reel can be prevented from becoming loose without application of a coating agent on the wire.

### BRIEF DESCRIPTION OF DRAWINGS

FIG. 1 is a perspective view that sees a rebar tying machine 2 in which a wire reel 9 according to an embodiment is used from an upper-left rear side;

FIG. 2 is a perspective view that sees the rebar tying machine 2 in which the wire reel 9 according to the embodiment is used from an upper-right rear side;

FIG. 3 is a perspective view that sees an internal structure of a tying machine body 4 of the rebar tying machine 2 in which the wire reel 9 according to the embodiment is used from the upper-right rear side;

FIG. 4 is a perspective view that sees a wire feeding mechanism 32 of the rebar tying machine 2 in which the wire reel 9 according to the embodiment is used from an upper-left front side;

FIG. 5 is a cross sectional view that sees the internal structure of the tying machine body 4 of the rebar tying machine 2 in which the wire reel 9 according to the embodiment is used from a left side;

FIG. 6 is a perspective view that sees the internal structure of the tying machine body 4 of the rebar tying machine 2 in which the wire reel 9 according to the embodiment is used from a left front side;

FIG. 7 is a perspective view that sees a reel supporting mechanism 30 of the rebar tying machine 2 in which the wire reel 9 according to the embodiment is used from the upper-left rear side;

FIG. 8 is a perspective view that sees the reel supporting mechanism 30 of the rebar tying machine 2 in which the wire reel 9 according to the embodiment is used from the upper-right rear side;

FIG. 9 is a perspective view that sees a cover 116 of the rebar tying machine 2 in which the wire reel 9 according to the embodiment is used from the upper-left rear side;

FIG. 10 is a cross sectional view that sees an internal structure of the reel supporting mechanism 30 of the rebar tying machine 2 in which the wire reel 9 according to the embodiment is used from an upper side, with the cover 116 being completely closed;

FIG. 11 is a perspective view that sees a left outer housing 14 and a relay member 104 of the rebar tying machine 2 in which the wire reel 9 according to the embodiment is used from the upper-left rear side;

FIG. 12 is a perspective view that sees a state of the reel supporting mechanism 30 of the rebar tying machine 2 in which the wire reel 9 according to the embodiment is used from the upper-left rear side when the cover 116 is completely closed;

FIG. 13 is a perspective view that sees a state of the reel supporting mechanism 30 of the rebar tying machine 2 in which the wire reel 9 according to the embodiment is used from the upper-left rear side when the cover 116 is slightly opened;

FIG. 14 is a perspective view that sees a state of the reel supporting mechanism 30 of the rebar tying machine 2 in which the wire reel 9 according to the embodiment is used from the upper-left rear side when the cover 116 is further opened;

FIG. 15 is a perspective view that sees a state of the reel supporting mechanism 30 of the rebar tying machine 2 in which the wire reel 9 according to the embodiment is used from the upper-left rear side when the cover 116 is completely opened; and

FIG. 16 is a cross sectional view that sees the internal structure of the reel supporting mechanism 30 of the rebar tying machine 2 in which the wire reel 9 according to the embodiment is used from the upper side, with the cover 116 being completely opened;

FIG. 17 is a perspective view of the wire reel 9 according to the embodiment before it is attached to the rebar tying machine 2;

FIG. 18 is a perspective view showing a configuration of a reel 10 of the wire reel 9 according to the embodiment;

FIG. 19 is a cross sectional view of the wire reel 9 according to the embodiment, showing how a wire 11 is wound on the reel 10 in a first layer;

FIG. 20 is the cross sectional view of the wire reel 9 according to the embodiment, showing how the wire 11 is wound on the reel 10 in a second layer;

FIG. 21 is a perspective view showing how the wire reel 9 according to the embodiment is manufactured;

FIG. 22 is the cross sectional view of the wire reel 9 according to the embodiment, showing how an engagement portion 11b of the wire 11 is formed; and

FIG. 23 is the cross sectional view of the wire reel 9 according to the embodiment, showing how the engagement portion 11b of the wire 11 is formed.

### DESCRIPTION OF EMBODIMENTS

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved wire reels for rebar tying machine, as well as methods for manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, a reel may include a trunk portion around which a wire is wound, and flange portions provided at both ends of the trunk portion, respectively.

According to the above configuration, the flange portions at the both ends of the trunk portion restrict movement of the wire wound around the trunk portion, in a direction along the trunk portion. Thus, when a later-wound part of the wire is caused to sink below an earlier-wound part of the wire, the later-wound part of the wire can be ensured to engage with the earlier-wound part of the wire.

In one or more embodiments, at an engagement portion, the later-wound part of the wire may be engaged with the earlier-wound part of the wire and one of the flange portions.

According to the above configuration, the flange portion can be used as a guide when the later-wound part of the wire is caused to sink below the earlier-wound part of the wire, by which the later-wound part of the wire can be easily caused to sink below the earlier-wound part of the wire.

In one or more embodiments, at least a part of the flange portions may be constituted of an elastic material.

According to the above configuration, the later-wound part of the wire can be easily caused to sink below the earlier-wound part of the wire by the flange portions being elastically deformed. Further, according to the above configuration, the engagement of the later-wound part of the wire with the earlier-wound part of the wire can be maintained by elastic resilience of the flange portions. Thus, the wire wound around the reel can be further prevented from becoming loose.

In one or more embodiments, a length of the wire from a distal end of the wire to the engagement portion may be equal to or greater than a predetermined length.

In the above configuration, by making the length of the wire from its distal end to the engagement portion of the wire longer than, for example, a length of the wire that a user needs to pull out to set the reel and the wire in the rebar tying machine, the wire wound around the reel can be prevented from becoming loose while the user sets the reel and the wire in the rebar tying machine.

### Embodiments

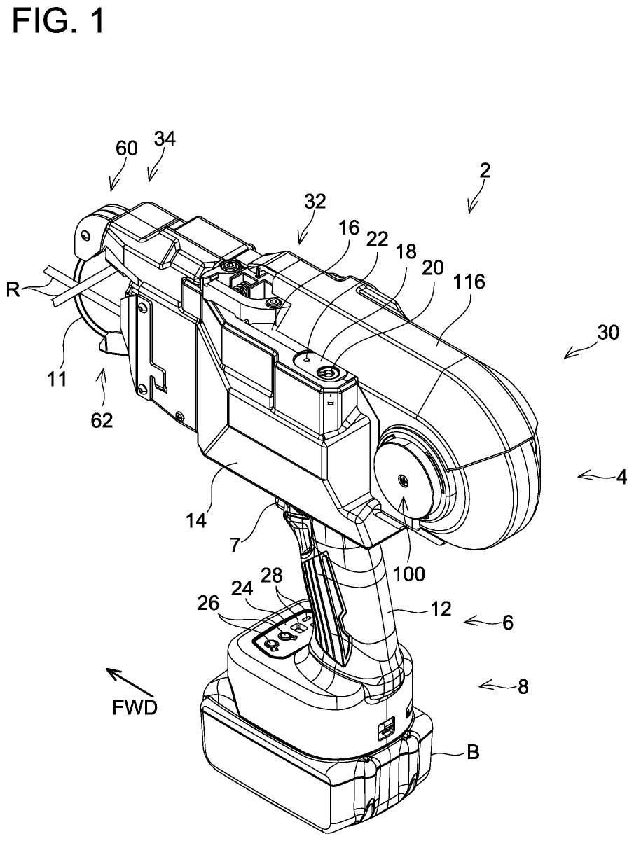

A wire reel 9 according to the present embodiment shown in FIG. 17 includes a reel 10 and a wire 11 wound around the reel 10. The wire reel 9 is used in a state where it is attached to a rebar tying machine 2 shown in FIG. 1. The rebar tying machine 2 is a power tool configured to tie a plurality of rebars R with the wire 11.

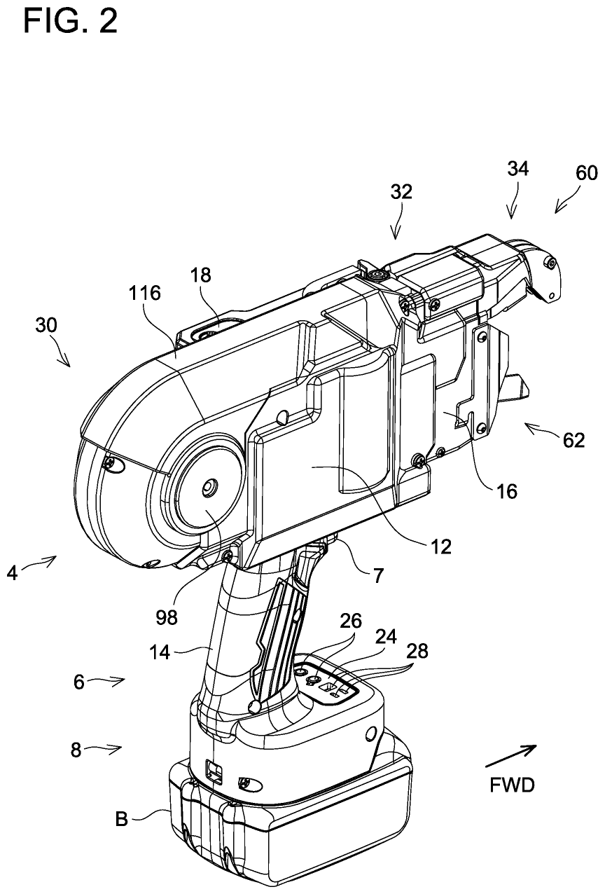

As shown in FIGS. 1 and 2, the rebar tying machine 2 comprises a tying machine body 4, a grip 6 provided below the tying machine body 4, and a battery interface 8 provided below the grip 6. A trigger 7 is provided at a front upper portion of the grip 6. A battery B is detachably attached below the battery interface 8. The tying machine body 4, the grip 6, and the battery interface 8 are integrated by coupling a right outer housing 12 and a left outer housing 14. Further, the tying machine body 4 is provided with an inner housing 16 between the right outer housing 12 and the left outer housing 14. The right outer housing 12, the left outer housing 14, and the inner housing 16 can each be termed a housing plate. A first operation display 18 is provided on an upper surface of the tying machine body 4. The first operation display 18 is provided with a main switch 20 for switching power of the rebar tying machine 2 between on and off, and a main power LED 22 for displaying an on/off state of the power of the rebar tying machine 2. A second operation display 24 is provided on a front upper surface of the battery interface 8. The second operation display 24 is provided with setting buttons 26 for setting a feed amount of the wire W and twisting intensity for the wire 11, and a display 28 for displaying contents set by the setting buttons 26. The battery B, the trigger 7, the first operation display 18, and the second operation display 24 are connected to a control board 134 to be described later.

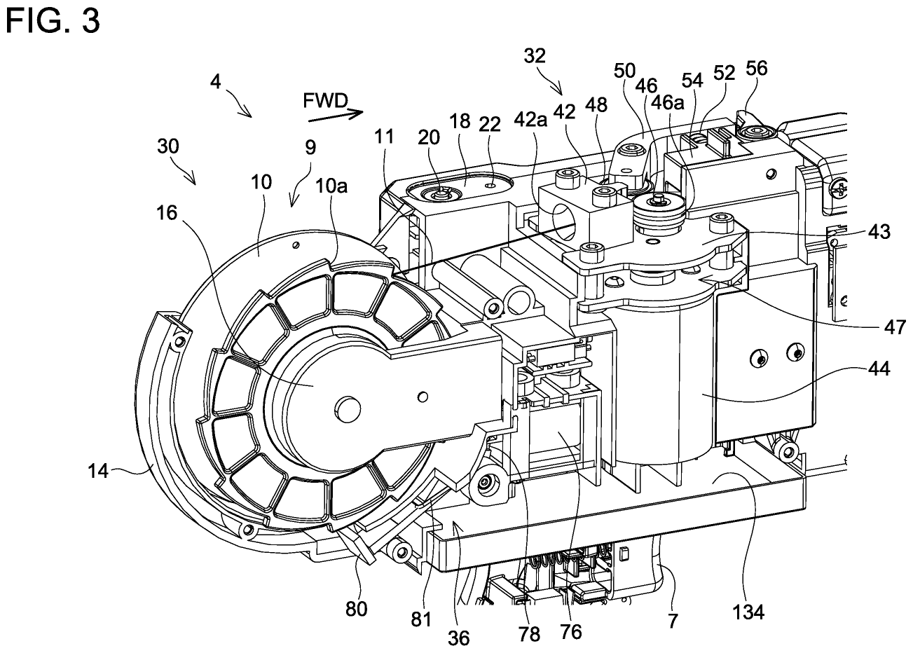

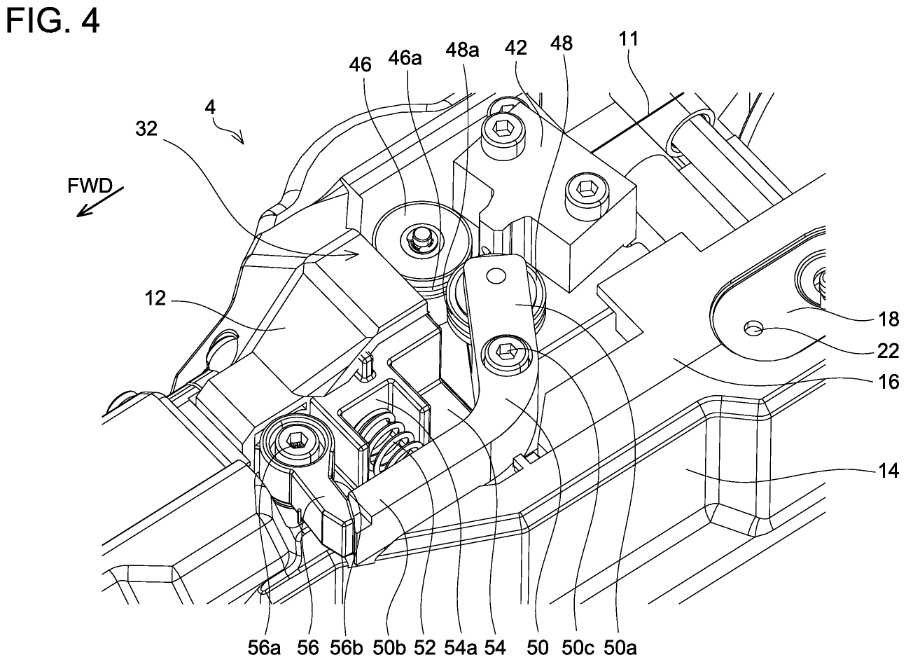

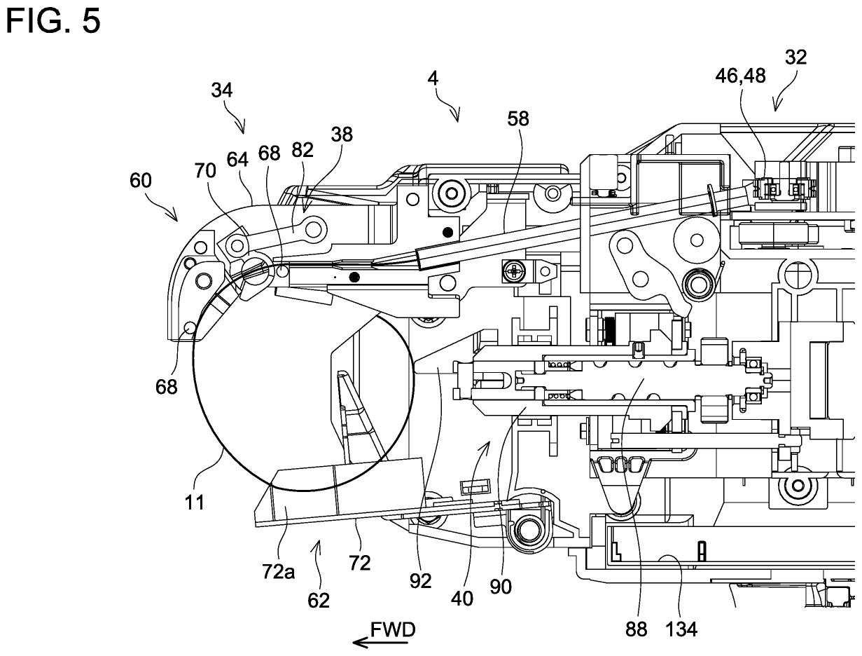

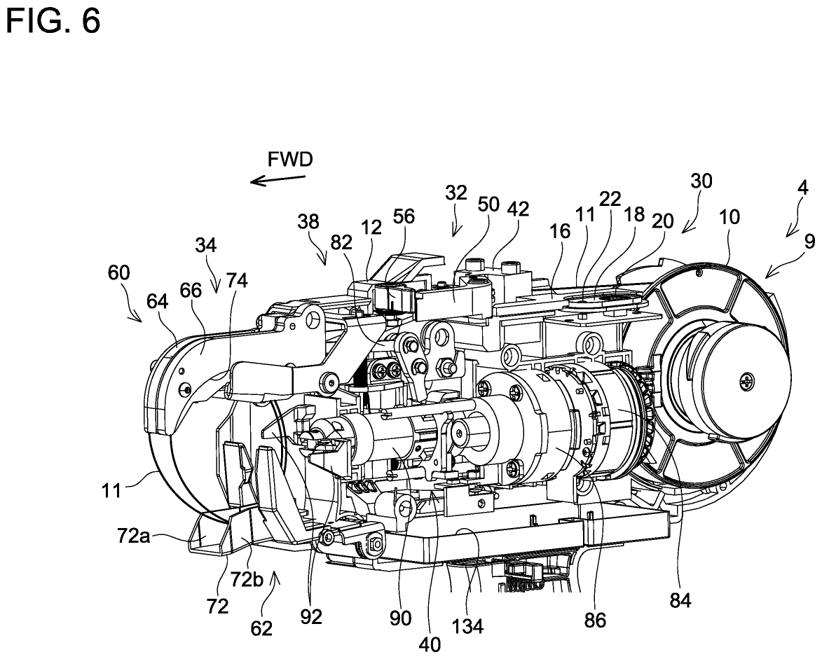

As shown in FIGS. 3 to 6, the tying machine body 4 primarily comprises a reel supporting mechanism 30 (see FIG. 3), a wire feeding mechanism 32 (see FIGS. 3 and 4), a wire guide mechanism 34 (see FIGS. 5 and 6), a braking mechanism 36 (see FIG. 3), a wire cutting mechanism 38 (see FIG. 5), a wire twisting mechanism 40 (see FIGS. 5 and 6), and the control board 134 (see FIGS. 3, 5, and 6). It should be noted that, for clearer depiction in the drawings, the right outer housing 12 and a cover 116 (details of which will be described later) are omitted in FIG. 3, the cover 116 is omitted in FIG. 4, and the left outer housing 14 and the cover 116 are omitted in FIG. 6. Further, in FIGS. 3 to 6, connection wires inside the rebar tying machine 2 are also omitted. The control board 134 is arranged at a central lower portion of the tying machine body 4 so as to traverse the inner housing 16. A part of the control board 134 is arranged on one side (right outer housing 12 side) as seen from the inner housing 16, and another part of the control board 134 is arranged on the other side (left outer housing 14 side) as seen from the inner housing 16.

The reel supporting mechanism 30 shown in FIG. 3 is configured to switch between a first state in which the reel supporting mechanism 30 detachably supports a reel 10, and a second state in which the reel supporting mechanism 30 undetachably supports the reel 10. Details of the reel supporting mechanism 30 will be described later.

The wire feeding mechanism 32 shown in FIGS. 3 and 4 is configured to feed out the wire 11, which is supplied from the reel 10 supported by the reel supporting mechanism 30 in the second state (see FIG. 3), to the wire guide mechanism 34 (see FIGS. 5 and 6) located on a front side of the tying machine body 4. The wire feeding mechanism 32 comprises a guiding member 42, a base member 43, a feeding motor 44, a driving gear 46, a reduction mechanism 47, a driven gear 48, a releasing lever 50, a compression spring 52, a lever holder 54, and a lock lever 56. The guiding member 42 comprises a truncated cone-shaped through hole 42a having a wide rear end and a narrow front end. The guiding member 42 is fixed to the base member 43. The driving gear 46 and the driven gear 48 are arranged on a front side relative to the guiding member 42. The driving gear 46 is coupled to the feeding motor 44 via the reduction mechanism 47, and it rotates by being driven by the feeding motor 44. The feeding motor 44 is connected to the control board 134 via a connection wire that is not shown. The control board 134 can control an operation of the feeding motor 44. A V-shaped groove 46a that extends in a circumferential direction of the driving gear 46 at a center in its height direction is provided on a side surface of the driving gear 46. As shown in FIG. 4, the driven gear 48 is rotatably supported by a gear arm 50a of the releasing lever 50. A V-shaped groove 48a that extends in a circumferential direction of the driven gear 48 at a center in its height direction is provided on a side surface of the driven gear 48. The releasing lever 50 is a substantially L-shaped member provided with the gear arm 50a and an operation arm 50b. The releasing lever 50 is pivotally supported by the base member 43 via a pivot axis 50c. The operation arm 50b of the releasing lever 50 is coupled to a spring receiving portion 54a of the lever holder 54 via the compression spring 52. The lever holder 54 is fixed by being clamped between the inner housing 16 and the left outer housing 14. The compression spring 52 biases the operation arm 50b towards a direction separating away from the spring receiving portion 54a. Under a normal state, torque that causes the driven gear 48 to approach the driving gear 46 is applied to the releasing lever 50 by biasing force of the compression spring 52, and the driven gear 48 is thereby pressed against the driving gear 46. Due to this, teeth of the driven gear 48 on its side surface and teeth of the driving gear 46 on its side surface engage with each other, and the wire 11 is held between the V-shaped groove 46a of the driving gear 46 and the V-shaped groove 48a of the driven gear 48. When the feeding motor 44 rotates the driving gear 46 under such a state, the driven gear 48 rotates in an opposite direction to the rotation direction of the driving gear 46, and the wire 11 held by the driving gear 46 and the driven gear 48 is fed out to the wire guide mechanism 34 so that the wire 11 is drawn out from the reel 10.

The lock lever 56 is pivotally supported by the lever holder 54 via a pivot axis 56a. The lock lever 56 is biased in a direction along which the lock lever 56 contacts with the operation arm 50b of the releasing lever 50 by a torsion spring that is not shown. The lock lever 56 includes a recess 56b configured to engage with a tip of the operation arm 50b of the releasing lever 50.

When a user of the rebar tying machine 2 presses the operation arm 50b in against the biasing force of the compression spring 52, the releasing lever 50 pivots about the pivot axis 50c and the driven gear 48 separates away from the driving gear 46. At this occasion, the lock lever 56 pivots about the pivot axis 56a and the tip of the operation arm 50b engages with the recess 56b, resulting in the operation arm 50b being retained in its pressed-in state. Upon when the wire 11 wound around the reel 10 is to be set in the wire feeding mechanism 32, the user presses the operation arm 50b in to separate the driven gear 48 from the driving gear 46, and in that state, arranges an end 11a of the wire 11 drawn out from the reel 10 between the driving gear 46 and the driven gear 48 through the through hole 42a of the guiding member 42. Then, when the user shifts the lock lever 56 in a direction along which the lock lever 56 separates from the operation arm 50b, the releasing lever 50 pivots about the pivot axis 50c and the driven gear 48 engages with the driving gear 46, and the wire 11 is held between the V-shaped groove 46a of the driving gear 46 and the V-shaped groove 48a of the driven gear 48.

The wire guide mechanism 34 shown in FIGS. 5 and 6 guides the wire 11 fed from the wire feeding mechanism 32 in a loop shape around the rebars R. The wire guide mechanism 34 comprises a guiding pipe 58, an upper curl guide 60, and a lower curl guide 62. A rearward end of the guiding pipe 58 is open toward an interface between the driving gear 46 and the driven gear 48. The wire 11 fed from the wire feeding mechanism 32 is fed to an inside of the guiding pipe 58. A forward end of the guiding pipe 58 is open toward an inside of the upper curl guide 60. The upper curl guide 60 is provided with a first guiding passage 64 for guiding the wire 11 fed from the guiding pipe 58, and a second guiding passage 66 (see FIG. 6) for guiding the wire 11 fed from the lower curl guide 62.

As shown in FIG. 5, the first guiding passage 64 is provided with plural guiding pins 68 for guiding the wire 11 so as to provide a downward curving profile to the wire 11, and a cutter 70 constituting a part of the wire cutting mechanism 38 to be described later. The wire 11 fed from the guiding pipe 58 is guided by the guiding pins 68 in the first guiding passage 64, passes through the cutter 70, and is fed out from a forward end of the upper curl guide 60 toward the lower curl guide 62. The wire 11 after passing through the cutter 70 is visible when the user looks into the upper curl guide 60 from below.

As shown in FIG. 6, the lower curl guide 62 is provided with a third guiding passage 72. The third guiding passage 72 comprises a right-side guiding wall 72a and a left-side guiding wall 72b for guiding the wire 11 fed from the forward end of the upper curl guide 60. The wire 11 guided by the lower curl guide 62 is fed toward a rear end of the second guiding passage 66 of the upper curl guide 60.

The second guiding passage 66 of the upper curl guide 60 is provided with an upper-side guiding wall 74 that guides the wire 11 fed from the lower curl guide 62 and feeds the wire 11 from the forward end of the upper curl guide 60 toward the lower curl guide 62.

The wire 11 fed from the wire feeding mechanism 32 is wound around the rebars R in the loop shape by the upper curl guide 60 and the lower curl guide 62. When the wire feeding mechanism 32 feeds out a feed amount of the wire 11 set by the user, it stops the feeding motor 44 to terminate the feeding of the wire 11.

The brake mechanism 36 shown in FIG. 3 stops rotation of the reel 10 in conjunction with the stop of the feeding of the wire 11 by the wire feeding mechanism 32. The brake mechanism 36 comprises a solenoid 76, a link 78, a brake arm 80, and a torsion spring 81. The solenoid 76 of the brake mechanism 36 is connected to the control board 134 by a connection wire that is not shown. The control board 134 is configured to control an operation of the brake mechanism 36. The reel 10 is provided with engaging portions 10a with which the brake arm 80 engages, and the engaging portions 10a are provided at predetermined angle intervals in a circumferential direction of the reel 10. In a state where the solenoid 76 is not energized, the brake arm 80 is separated from the engaging portions 10a of the reel 10 by biasing force of the torsion spring 81. When the solenoid 76 is energized, the brake arm 80 pivots using the link 78 against the biasing force of the torsion spring 81, and the brake arm 80 engages with one of the engaging portions 10a of the reel 10. When the feeding of the wire 11 is performed by the wire feeding mechanism 32, the brake mechanism 36 does not energize the solenoid 76 to separate the brake arm 80 from the engaging portions 10a of the reel 10. Due to this, the reel 10 can freely rotate, and the wire feeding mechanism 32 can draw out the wire 11 from the reel 10. Further, when the feeding of the wire 11 by the wire feeding mechanism 32 is stopped, the brake mechanism 36 energizes the solenoid 76 to engage the brake arm 80 with one of the engaging portions 10a of the reel 10. Due to this, the rotation of the reel 10 is inhibited. Due to this, the wire 11 can be prevented from becoming loose between the reel 10 and the wire feeding mechanism 32 by the reel 10 continuing to rotate by inertia even after the wire feeding mechanism 32 had stopped feeding out the wire 11.

The wire cutting mechanism 38 shown in FIG. 5 cuts the wire 11 in a state where the wire 11 is wound around the rebars R. The wire cutting mechanism 38 comprises the cutter 70 and a link 82. The link 82 rotates the cutter 70 in cooperation with the wire twisting mechanism 40 to be described later. The wire 11 passing through an inside of the cutter 70 is cut by the rotation of the cutter 70.

The wire twisting mechanism 40 shown in FIG. 6 ties the rebars R with the wire 11 by twisting the wire 11 wound around the rebars R. The wire twisting mechanism 40 comprises a twisting motor 84, a reduction mechanism 86, a screw shaft 88 (see FIG. 5), a sleeve 90, and a pair of hooks 92.

Rotation of the twisting motor 84 is transmitted to the screw shaft 88 through the reduction mechanism 86. The twisting motor 84 is configured to rotate in a forward direction or in a reverse direction, and the screw shaft 88 is configured to rotate in the forward direction or in the reverse direction according to the rotation of the twisting motor 84. The twisting motor 84 is connected to the control board 134 by a connection wire that is not shown. The control board 134 is configured to control an operation of the twisting motor 84. The sleeve 90 is arranged to cover a periphery of the screw shaft 88. In a state where rotation of the sleeve 90 is inhibited, the sleeve 90 moves forward when the screw shaft 88 rotates in the forward direction, and when the screw shaft 88 rotates in the reverse direction, the sleeve 90 moves backward. Further, in a state where the rotation of the sleeve 90 is allowed, the sleeve 90 rotates with the screw shaft 88 when the screw shaft 88 rotates. Further, when the sleeve 90 moves forward from its initial position to a predetermined position, the link 82 of the wire cutting mechanism 38 rotates the cutter 70. The pair of hooks 92 is provided at a forward end of the sleeve 90, and it opens and closes according to a position of the sleeve 90 in a forward-and-backward direction. When the sleeve 90 moves forward, the pair of hooks 92 closes and holds the wire 11. On the contrary, when the sleeve 90 moves backward, the pair of hooks 92 opens and releases the wire 11.

The wire twisting mechanism 40 rotates the twisting motor 84 in the state where the wire 11 is wound around the rebars R. At this occasion, the rotation of the sleeve 90 is inhibited, so the sleeve 90 and the pair of hooks 92 both move forward by the rotation of the screw shaft 88, and the pair of hooks 92 closes to hold the wire 11. Then, when the rotation of the sleeve 90 is allowed, the sleeve 90 and the pair of hooks 92 rotate by the rotation of the screw shaft 88. Due to this, the wire 11 is twisted and the rebars R are thereby tied. Twisting intensity for the wire 11 can be set in advance by the user. When the wire 11 is twisted to the preset twisting intensity, the wire twisting mechanism 40 rotates the twisting motor 84 in the reverse direction. At this occasion, the rotation of the sleeve 90 is inhibited, so the sleeve 90 moves backward by the rotation of the screw shaft 88, and the pair of hooks 92 also moves backward while gradually opening, resulting in releasing the wire 11. Thereafter, the pair of hooks 92 moves backward to its initial position and the rotation of the sleeve 90 is allowed, and the pair of hooks 92 thereby returns to its initial angle.

As shown in FIG. 1, when the user arranges the rebar tying machine 2 so that the plural rebars R are positioned between the upper curl guide 60 and the lower curl guide 62, and pulls the trigger 7, the rebar tying machine 2 performs a series of motions to wind the wire 11 around the rebars R by the wire feeding mechanism 32, the wire guide mechanism 34, and the braking mechanism 36, and to cut and twist the wire 11 wound on the rebars R by the wire cutting mechanism 38 and the wire twisting mechanism 40.

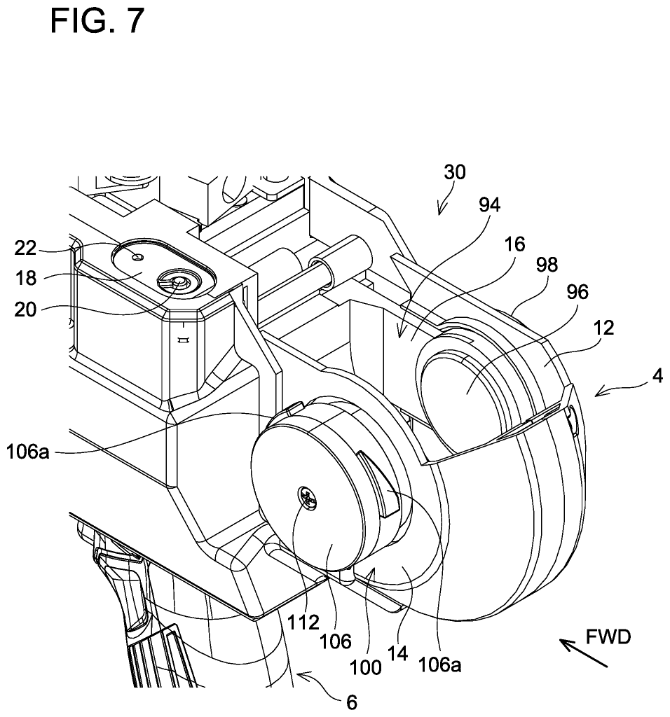

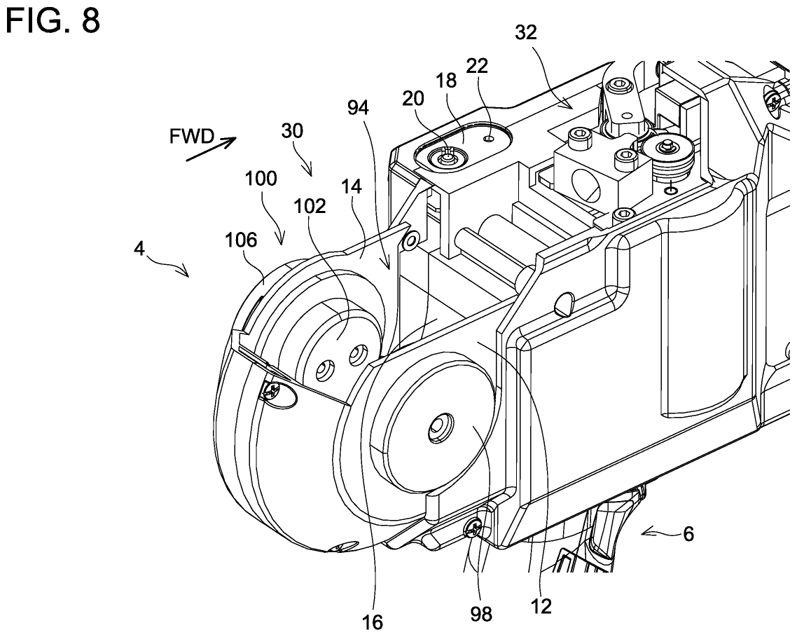

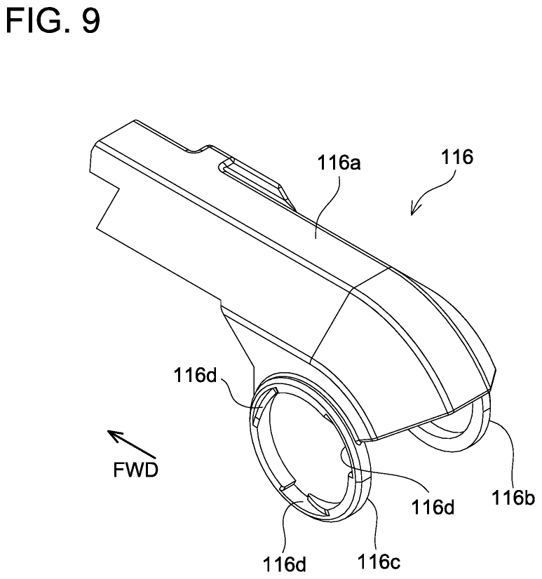

Hereinbelow, details of the reel supporting mechanism 30 will be described. As shown in FIGS. 7 to 11, the reel supporting mechanism 30 comprises a reel loading chamber 94, a fixed bearing 96, a cover holder 98, a movable bearing 100, and the cover 116 (see FIG. 9). It should be noted that, for clearer depiction in the drawings, the wire reel 9 and the cover 116 are omitted in FIGS. 7 and 8.

The reel loading chamber 94 has a shape by which the wire reel 9 can be placed inside thereof. The reel loading chamber 94 has its top portion opened, and the wire reel 9 can be inserted into or taken out from this top portion. A front surface of the reel loading chamber 94 is defined by the inner housing 16. A right surface of the reel loading chamber 94 is defined by the right outer housing 12 and the inner housing 16. A left surface of the reel loading chamber 94 is defined by the left outer housing 14. Rear and bottom surfaces of the reel loading chamber 94 are defined by the right outer housing 12, the left outer housing 14, and the inner housing 16. Along a front-and-rear direction of the tying machine body 4, the front, bottom, and rear surfaces of the reel loading chamber 94 have an arc shape bulging downward. Due to this, when the wire reel 9 is set in the reel loading chamber 94, the wire reel 9 is placed on a lowermost portion of the bottom surface of the reel loading chamber 94.

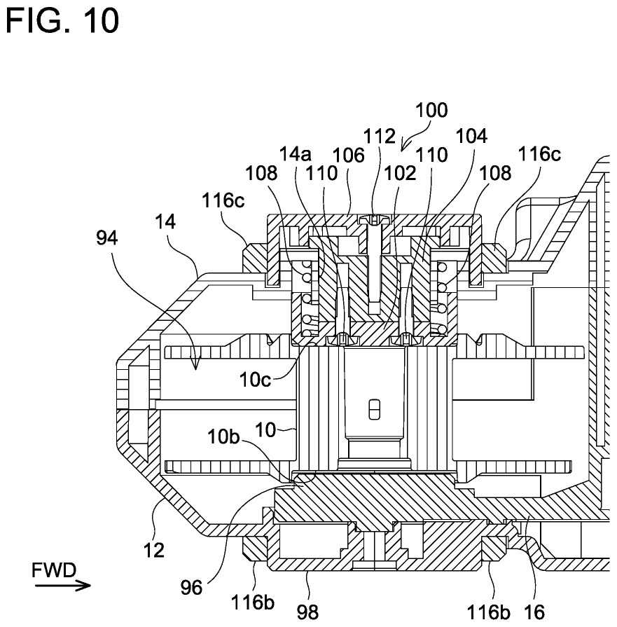

As shown in FIG. 7, the fixed bearing 96 is arranged to protrude toward the inside of the reel loading chamber 94 from the right surface of the reel loading chamber 94. Specifically, the fixed bearing 96 is arranged on a surface of the inner housing 16 that faces the left outer housing 14 so as to protrude toward the left outer housing 14. In the present embodiment, the fixed bearing 96 is integrated with the inner housing 16. The fixed bearing 96 has a cylindrical outer shape. A center axis of the cylindrical shape of the fixed bearing 96 substantially matches a left-and-right direction of the tying machine body 4. A corner at a distal end of the fixed bearing 96 has a tapered shape. As shown in FIG. 10, a cylinder-shaped bearing groove 10b is provided at a center of a surface of the reel 10 that faces the fixed bearing 96. The fixed bearing 96 engages with the bearing groove 10b of the reel 10 to rotatably support the reel 10.

As shown in FIG. 8, the cover holder 98 is arranged on an outer surface of the right outer housing 12. In this embodiment, the cover holder 98 is integrated with the right outer housing 12. The cover holder 98 has a cylindrical outer shape. A center axis of the cylindrical shape of the cover holder 98 substantially matches the center axis of the cylindrical shape of the fixed bearing 96.

The movable bearing 100 is arranged on the left surface of the reel loading chamber 94. Specifically, the movable bearing 100 is arranged to penetrate the left outer housing 14. As shown in FIG. 10, the movable bearing 100 comprises a bearing member 102, a relay member 104, a cover holder member 106, and a compression spring 108.

As shown in FIG. 8, the bearing member 102 is arranged to protrude from the left surface of the reel loading chamber 94 into the inside of the reel loading chamber 94. The bearing member 102 has a cylindrical outer shape. A corner at a distal end of the bearing member 102 has a tapered shape. A center axis of the cylindrical shape of the bearing member 102 substantially matches the center axis of the cylindrical shape of the fixed bearing 96. It should be noted that, hereinbelow, the center axis of the cylindrical shape of the bearing member 102 may be referred to as a center axis of the movable bearing 100. As shown in FIG. 10, a cylinder-shaped bearing groove 10c is provided at a center of a surface of the reel 10 that faces the bearing member 102. The bearing member 102 engages with the bearing groove 10c of the reel 10 to rotatably support the reel 10. The bearing member 102 is fixed to the relay member 104 via fixation pieces 110.

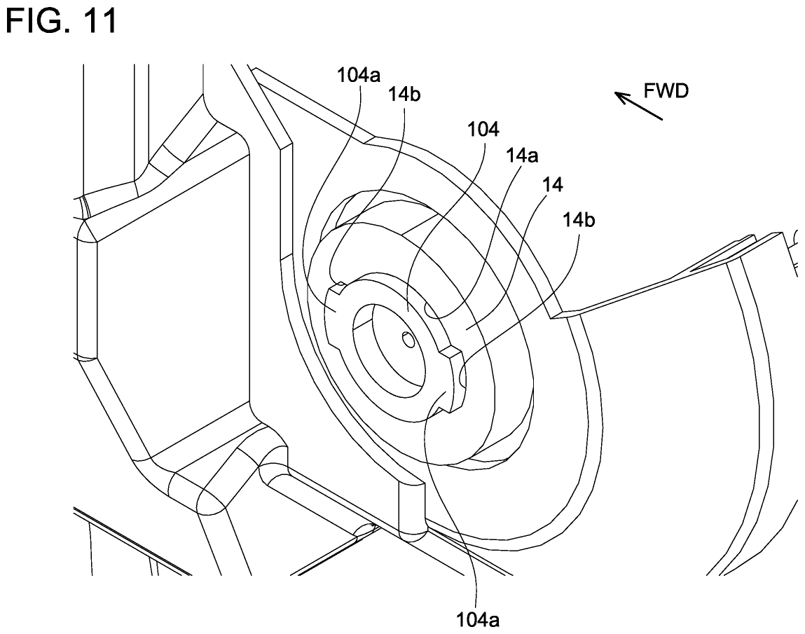

As shown in FIG. 11, the relay member 104 is supported by the left outer housing 14 by penetrating through a through hole 14a provided on the left outer housing 14. The relay member 104 is supported by the left outer housing 14 so as to be slidable along a center axis direction of the movable bearing 100 (that is, the left-and-right direction of the tying machine body 4). Projections 104a that extend along the center axis direction of the movable bearing 100 are provided on an outer surface of the relay member 104, and recesses 14b corresponding to the projections 104a are provided in the through hole 14a. Due to this, the relay member 104 is supported by the left outer housing 14 so as to be incapable of rotating about the center axis of the movable bearing 100 (that is, about the left-and-right direction of the tying machine body 4). As shown in FIG. 10, the relay member 104 is fixed to the cover holder member 106 via a fixation piece 112.

As shown in FIG. 7, the cover holder member 106 is arranged outside the left outer housing 14. The cover holder member 106 has a cylindrical outer shape. A center axis of the cylindrical shape of the cover holder member 106 substantially matches the center axis of the cylindrical shape of the bearing member 102. Further, cam projections 106a are provided on a cylindrical outer surface of the cover holder member 106 at predetermined angle intervals in a circumferential direction.

As shown in FIG. 10, the compression spring 108 couples the left outer housing 14 and the bearing member 102. The compression spring 108 biases the bearing member 102 in a direction approaching the fixed bearing 96.

As shown in FIG. 9, the cover 116 comprises a cover body 116a, a right-side attachment 116b, and a left-side attachment 116c. The cover body 116a has a shape that covers the top portion of the reel loading chamber 94 and a top portion of the wire feeding mechanism 32. More specifically, the cover body 116a has a shape that covers the wire reel 9 inside the reel loading chamber 94, and the guiding member 42, the base member 43, the driving gear 46, and the driven gear 48 of the wire feeding mechanism 32 from above. With the cover body 116a covering the top portion of the reel loading chamber 94, the wire 11 is prevented from loosening and being detached from the reel 10, and water, dust, sand, and the like can be prevented from entering into the reel loading chamber 94 from outside. With the cover body 116a covering the top portion of the wire feeding mechanism 32, water, dust, sand, and the like can be prevented from entering into the wire feeding mechanism 32 from outside. The cover body 116a has a shape that is easily gripped by the user of the rebar tying machine 2 from its left and right sides for easy opening and closing operations of the cover 116. It should be noted that a projection or a recess to place user's finger on when the user pulls the cover 116 up backwards may be provided on the cover body 116a. Further, the cover body 116a is constituted of a transparent material such that the user can visibly recognize a state of the wire reel 9 from outside even when the cover 116 is closed.

The right-side attachment 116b has a ring shape that can be attached slidably on an outer surface of the cover holder 98 shown in FIG. 8. The left-side attachment 116c has a ring shape that can be attached slidably on the outer surface of the cover holder member 106 of the movable bearing 100 shown in FIG. 7. Further, the left-side attachment 116c is provided with cam grooves 116d at the predetermined angle intervals in the circumferential direction so as to correspond to the cam projections 106a of the cover holder member 106. The cam grooves 116d are arranged at positions and are given a shape, by which the cam projections 106a enter completely therein when the cover 116 is completely closed. Further, the cam grooves 116d are arranged so as to be disconnected with the cam projections 106a when the cover 116 is completely opened. The cam projections 106a and the cam grooves 116d constitute a cam mechanism.

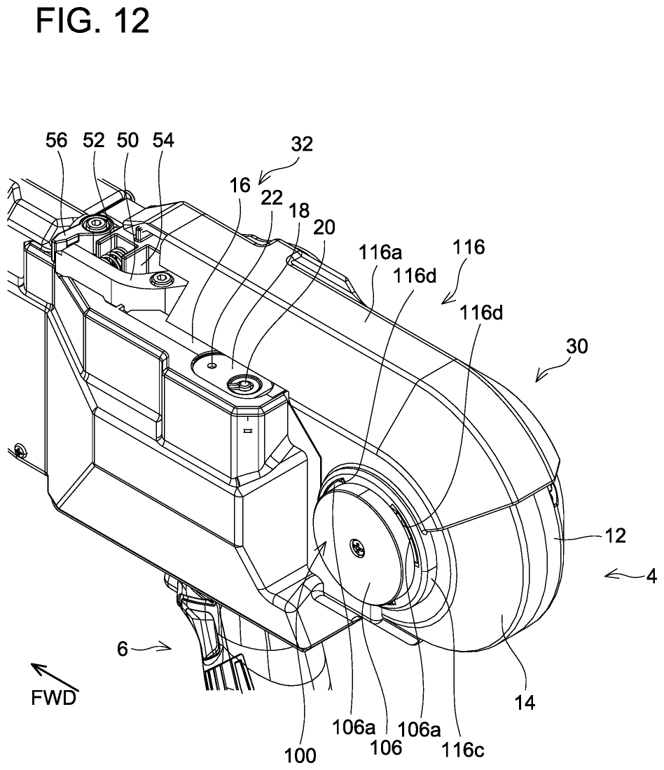

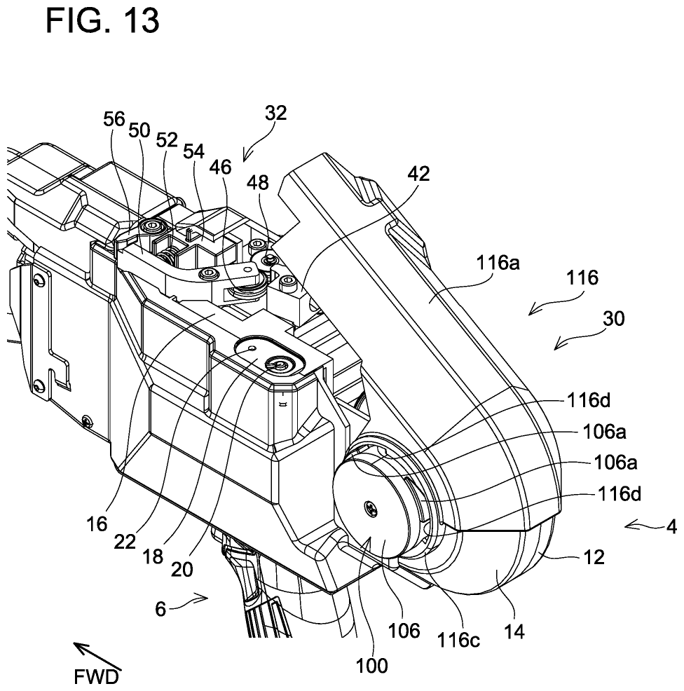

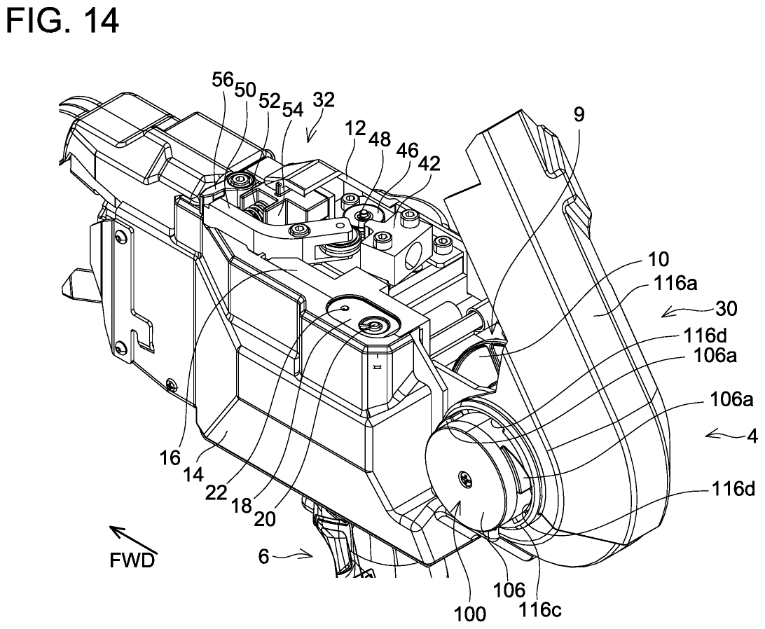

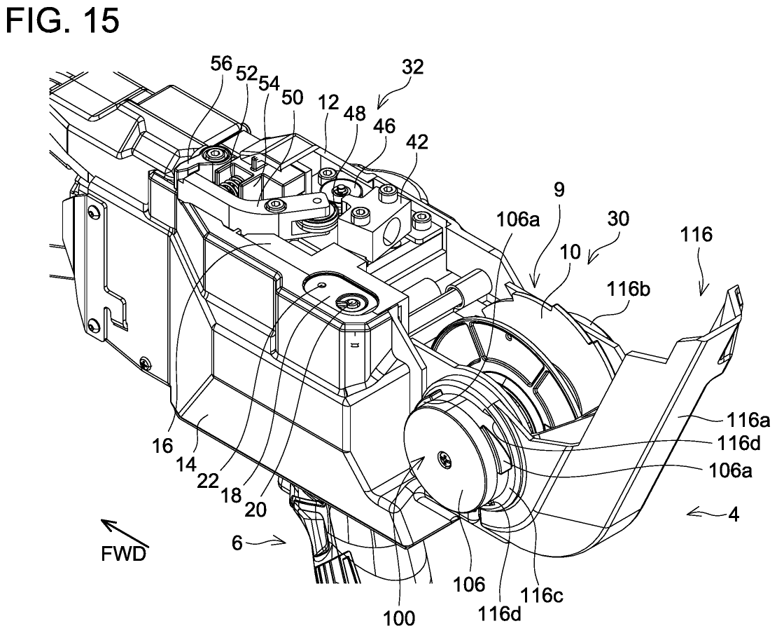

As shown in FIG. 12, when the cover 116 is completely closed, the compression spring 108 applies the biasing force toward a right side of the tying machine body 4 (that is, in the direction approaching the fixed bearing 96) on the bearing member 102, the relay member 104, and the cover holder member 106, so a force in a direction along which the cam projections 106a are pressed into the cam grooves 116d is acting thereon. That is, in a closed state where the cover 116 is closed, the closed state is maintained by the biasing force of the compression spring 108. When the user of the rebar tying machine 2 grips the cover body 116a and pulls up the cover body 116a backward against the biasing force of the compression spring 108 from the closed state, the right-side attachment 116b rotates while sliding relative to the cover holder 98 and the left-side attachment 116c also rotates while sliding relative to the cover holder member 106. At this timing, as shown in FIG. 13, the cam projections 106a are gradually pushed out from the cam grooves 116d, and the cover holder member 106, the relay member 104, and the bearing member 102 collectively move toward a left side of the tying machine body 4 (that is, in a direction separating from the fixed bearing 96). It should be noted that if the user of the rebar tying machine 2 releases the cover body 116a from his/her hand in this state, the force that presses the cam projections 106a into the cam grooves 116d is exerted by the biasing force of the compression spring 108, the cover 116 pivots in its closing direction, and the cover 116 returns to its closed state. When the user of the rebar tying machine 2 further pulls up the cover body 116a backward against the biasing force of the compression spring 108 from the state shown in FIG. 13, the cam projections 106a become completely disconnected from the cam grooves 116d as shown in FIG. 14, and the cam projections 106a slide while making contact with portions of the left-side attachment 116c where the cam grooves 116d are not provided. It should be noted that even if the user of the rebar tying machine 2 releases the cover body 116a from his/her hand in this state, the biasing force of the compression spring 108 does not act as the force in the direction to close the cover 116 since the cam projections 106a are located at positions disconnected from the cam grooves 116d, and thus the cover 116 maintains its current open angle as it is. When the user of the rebar tying machine 2 further pulls up the cover body 116a backward from the state shown in FIG. 14, the cover 116 becomes completely opened as shown in FIG. 15.

When the user of the rebar tying machine 2 grips the cover body 116a and pushes down the cover body 116a forward from the state shown in FIG. 15 where the cover 116 is completely opened, the right-side attachment 116b rotates while sliding relative to the cover holder 98, and the left-side attachment 116c also rotates while sliding relative to the cover holder member 106. Then, as shown in FIGS. 14 and 13, when the cam projections 106a shifts, by the rotation of the cover 116, from the state where the cam projections 106a are completely disconnected from the cam grooves 116d to the state where the cam projections 106a has entered into the cam grooves 116d, the bearing member 102, the relay member 104, and the cover holder member 106 collectively move toward the right side of the tying machine body 4 (that is, in the direction approaching the fixed bearing 96) by the biasing force of the compression spring 108. Further, since the force in the direction to press the cam projections 106a into the cam grooves 116d is exerted by the biasing force of the compression spring 108, the cover 116 pivots in its closing direction even if the user of the rebar tying machine 2 releases the cover body 116a from his/her hand, and the cover 116 becomes completely closed as shown in FIG. 12.

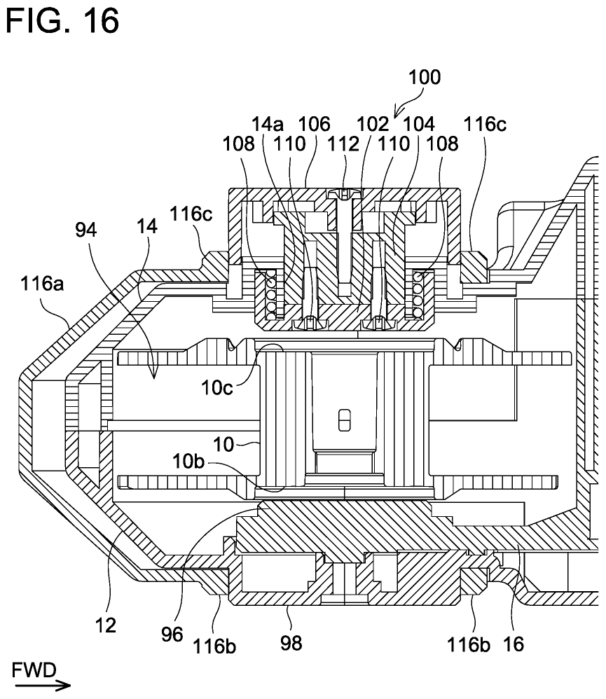

Procedures for setting the wire reel 9 in the rebar tying machine 2 will be described. Firstly, the user brings the cover 116 to its opened state, and places the wire reel 9 in the reel loading chamber 94. As shown in FIG. 16, at this timing, the bearing member 102 is arranged at a position where it does not interfere with the reel 10 upon inserting the wire reel 9 into or taking out the wire reel 9 from the reel loading chamber 94, so the reel 10 is placed on the bottom surface of the reel loading chamber 94 without engaging with the fixed bearing 96 or the bearing member 102. In this state, the wire reel 9 can be said as being detachably supported by the reel supporting mechanism 30. Thereafter, the user draws out the wire 11 from the reel 10, and sets the wire 11 in the wire feeding mechanism 32. Thereafter, when the user closes the cover 116, the bearing member 102 moves, along the direction approaching the fixed bearing 96, to a position where it engages with the bearing groove 10c of the reel 10, and as shown in FIG. 10, the bearing member 102 engages with the bearing groove 10c of the reel 10 and the bearing groove 10b of the reel 10 also engages with the fixed bearing 96, as a result of which the wire reel 9 is undetachably supported by the reel supporting mechanism 30.

As shown in FIG. 10, in the state where the wire reel 9 is set in the rebar tying machine 2, the reel 10 is supported rotatably by the fixed bearing 96 and the bearing member 102. When the wire 11 is to be drawn out from the reel 10 by the wire feeding mechanism 32, the reel 10 rotates while sliding relative to the fixed bearing 96 and the bearing member 102. It should be noted that the reel 10 may be configured to rotate without sliding relative to the fixed bearing 96 by configuring the fixed bearing 96 to be rotatable relative to the inner housing 16, or the reel 10 may be configured to rotate without sliding relative to the bearing member 102.

Procedures to remove the wire reel 9 from the rebar tying machine 2 will be described. When the user opens the cover 116, the bearing member 102 separates away from the bearing groove 10c of the reel 10 and the bearing groove 10b of the reel 10 also separates away from the fixed bearing 96 by the bearing member 102 moving in the direction separating from the fixed bearing 96, which leaves the reel 10 in the state of being placed on the bottom surface of the reel loading chamber 94. As shown in FIG. 16, under this state, the bearing member 102 has moved to the position where the bearing member 102 does not interfere with the reel 10 when the wire reel 9 is inserted into or taken out from the reel loading chamber 94. The user detaches the wire 11 extending from the reel 10 from the wire feeding mechanism 32, and thereafter can remove the wire reel 9 from the reel loading chamber 94.

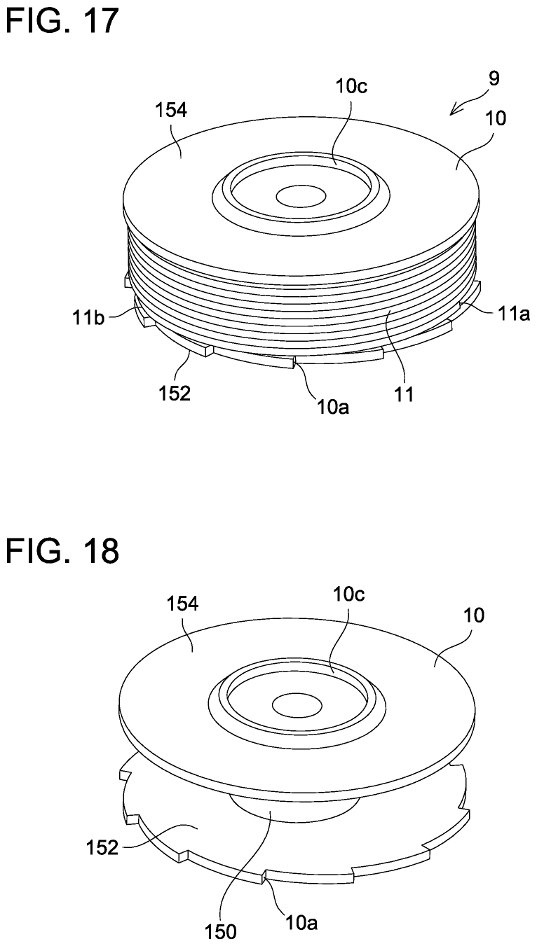

A manufacturing method of the wire reel 9 will be described below. As shown in FIG. 18, the reel 10 of the wire reel 9 includes a trunk portion 150 around which the wire 11 is wound, and flange portions 152, 154 provided at both ends of the trunk portion 150, respectively. The reel 10 is constituted of a resin which is an elastic material, and the trunk portion 150 and the flange portions 152, 154 are configured integrally and seamlessly. The trunk portion 150 has a substantially cylindrical shape. The flange portions 152, 154 each have a substantially disc shape. The flange portion 152, which is one of the flange portions, is provided with an engaging portion 10a and the bearing groove 10b (see FIG. 10, FIG. 16). The flange portion 154, which is the other of the flange portions, is provided with the bearing groove 10c. A center axis of the trunk portion 150 and center axes of the flange portions 152, 154 substantially coincide with a rotation axis of the reel 10 when it is rotatably supported by the fixed bearing 96 and the bearing member 102 of the rebar tying machine 2.

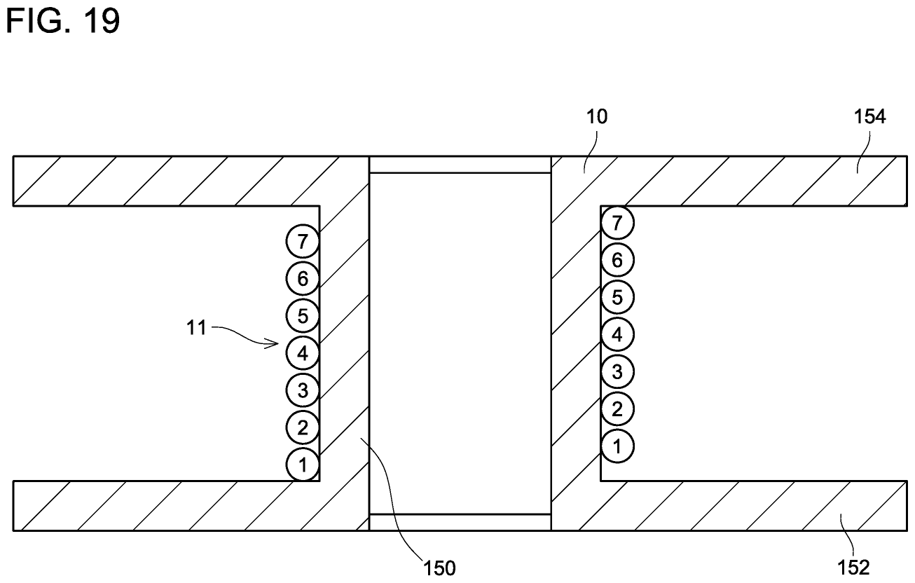

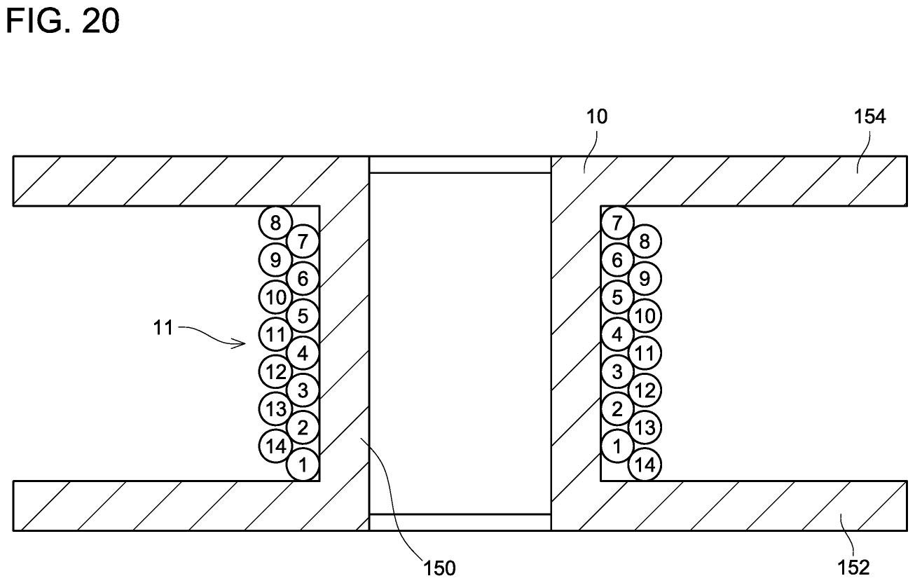

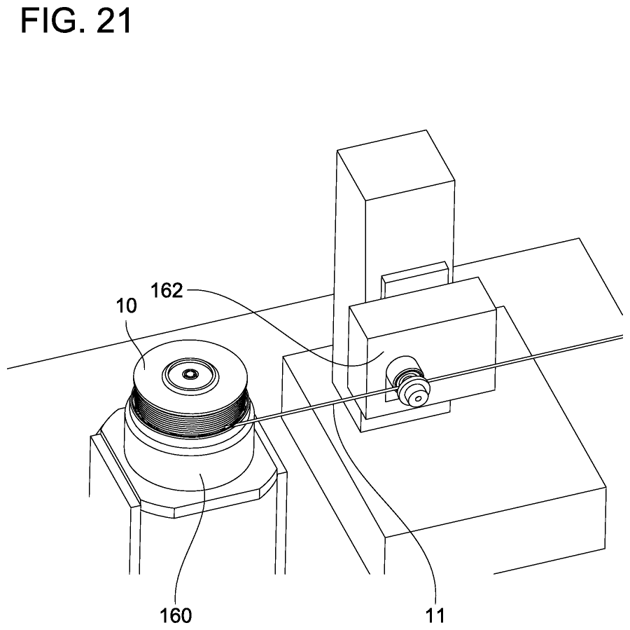

In the wire reel 9, the wire 11 is wound around the trunk portion 150 of the reel 10 in multiple layers. As shown in FIG. 19, in a first layer, the wire 11 is wound on an outer circumferential surface of the trunk portion 150 of the reel 10 in a helical shape that extends from the one flange portion 152 toward the other flange portion 154. As shown in FIG. 20, a second layer of the wire 11 starts from a site where the first layer reaches the other flange portion 154, and the second layer is wound on an outer circumferential surface of a part of the wire 11 that has been already wound around the trunk portion 150 (i.e., an outer circumferential surface of the first layer of the wire 11) in a helical shape that extends from the other flange portion 154 toward the one flange portion 152. A third layer of the wire 11 starts from a site where the second layer reaches the other flange portion 154, and the third layer is wound on an outer circumferential surface of a part of the wire 11 that has been already wound around the trunk portion 150 (i.e., an outer circumferential surface of the second layer of the wire 11) in a helical shape that extends from the one flange portion 152 toward the other flange portion 154. As above, in the wire reel 9 according to the present embodiment, the wire 11 is wound around the trunk portion 150 of the reel 10 in multiple layers.

As shown in FIG. 17, in a state where the wire reel 9 is unused, the wire 11 has an engagement portion 11b provided at a position that is apart by a predetermined length L from a distal end 11a of the wire 11. At the engagement portion 11b, an earlier-wound part of the wire 11 is engaged with a later-wound part of the wire 11 by the later-wound part of the wire 11 sinking below the earlier-wound part of the wire 11, which prohibits the later-wound part of the wire 11 from moving in a direction separating away from the trunk portion 150 (i.e., in an outward radial direction of the trunk portion 150). In other words, at the engagement portion 11b, a part of the wire 11 that is a short length apart from the distal end 11a is engaged with a part of the wire 11 that is a longer length apart from the distal end 11a by sinking below the part of the wire 11 that is the longer length apart from the distal end 11a, which prohibits the part of the wire 11 that is the short length apart from the distal end 11a from moving in the direction separating away from the trunk portion 150. Since the wire 11 of the wire reel 9 of the present embodiment includes the engagement portion 11b, it can prevent the wire 11 from becoming loose before the reel 10 and the wire 11 are set in the rebar tying machine 2. The engagement portion 11b of the wire 11 is configured to be disengaged by the user pulling the later-wound part of the wire 11 (i.e., the part of the wire 11 that sinks below the earlier-wound part of the wire 11) hard in the direction separating away from the trunk portion 150, as well as, by pulling out the wire 11 from the reel 10 by actuation of the feeding motor 44 after the reel 10 and the wire 11 has been set in the rebar tying machine 2.

As shown in FIG. 21, in manufacturing of the wire reel 9, the reel 10 on which the wire 11 has not been wound yet is firstly prepared, and this reel 10 is attached to a reel holding jig 160. Then, an end of the wire 11 which is supplied from a wire supply source (not shown) is fixed to the trunk portion 150 of the reel 10 via a wire feeding jig 162. After this, the wire feeding jig 162 moves a feeding position of the wire 11 up and down (in directions along the center axis of the trunk portion 150) in a reciprocating manner while the reel holding jig 160 is rotating the reel 10, by which the wire 11 is wound around the trunk portion 150 of the reel 10.

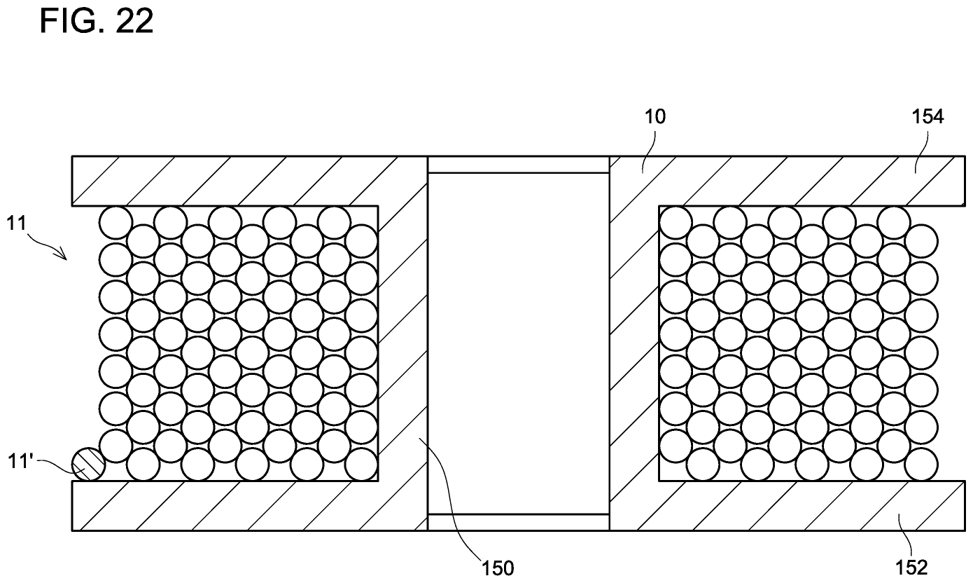

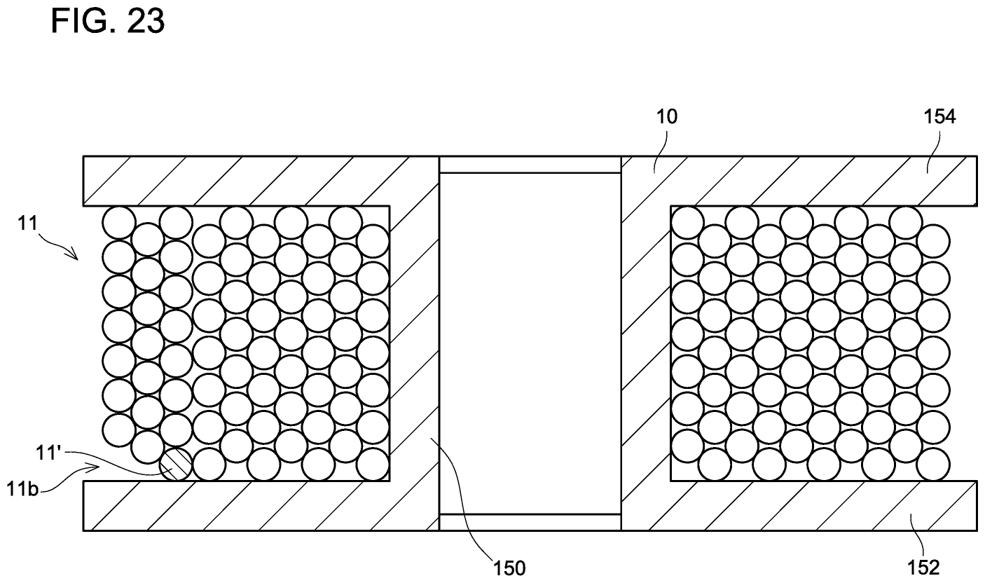

As shown in FIG. 22, when the wire 11 has been sufficiently wound around the trunk portion 150 of the reel 10, the wire feeding jig 162 restrains the wire 11 to stop feeding the wire 11 while the reel holding jig 160 is still rotating the reel 10. Due to this, a high tensile force is applied on a part of the wire 11 that is between the reel holding jig 160 and the wire feeding jig 162. As a result, as shown in FIG. 23, a wire 11′, which is under the tensile force from the wire feeding jig 162, is wound while sinking toward the trunk portion 150 by pushing away lower layer(s) of the wire 11 that has been already wound. As such, the later-wound wire part 11′ engages with the earlier-wound part of the wire 11, by which the engagement portion 11b is formed. After this, the wire feeding jig 162 releases the restraint on the wire 11 and starts feeding the wire 11 again while the reel holding jig 160 is rotating the reel 10. The wire reel 9 is completed when the wire 11 is cut off at a position apart by the predetermined length from the engagement portion 11b.

In the wire reel 9, various lengths may be employed as the length from the distal end 11a of the wire 11 to the engagement portion 11b. For example, the length from the distal end 11a of the wire 11 to the engagement portion 11b may be equal to or greater than a length from a feeding position of the wire 11 at the reel 10 to a position where the wire 11 is held between the driving gear 46 and the driven gear 48 (e.g., 80 mm) in a state where the wire reel 9 is attached to the rebar tying machine 2. In this case, until the user finishes placing the wire reel 9 in the reel loading chamber 94 and arranging the distal end 11a of the wire 11 pulled out from the reel 10 at a position between the driving gear 46 and the driven gear 48 through the through hole 42a of the guiding member 42, the engagement portion 11b prevents the wire 11 from becoming loose. Thus, working performance of the user can be improved. Alternatively, the length from the distal end 11a of the wire 11 to the engagement portion 11b may be equal to or greater than a length from the feeding position of the wire 11 at the reel 10 to a position past the cutter 70 (e.g., 270 mm) in the state where the wire reel 9 is attached to the rebar tying machine 2. In a case where the wire 11 is set such that the distal end 11a of the wire 11 reaches the position past the cutter 70, the user can visually confirm that the distal end 11a of the wire 11 is past the cutter 70 by looking the upper curl guide 60 from below, and further a length of the wire 11 required for a first round of tying operation can be ensured. According to this configuration, until the user finishes setting the wire 11 such that the distal end 11a of the wire 11 reaches the position past the cutter 70, the engagement portion 11b prevents the wire 11 from becoming loose. Thus, working performance of the user can be improved. Alternatively, the length from the distal end 11a of the wire 11 to the engagement portion 11b may be equal to or greater than a length from the feeding position of the wire 11 at the reel 10 to a position past the upper curl guide 60 (e.g., 300 mm) in the state where the wire reel 9 is attached to the rebar tying machine 2. In a case where the wire 11 is set such that the distal end 11a of the wire 11 reaches the position past the upper curl guide 60, the user can visually confirm that the distal end 11a of the wire 11 is past the upper curl guide 60 with ease, and further the length of the wire 11 required for the first round of tying operation can be ensured. According to this configuration, until the user finishes setting the wire 11 such that the distal end 11a of the wire 11 reaches the position past the upper curl guide 60, the engagement portion 11b prevents the wire 11 from becoming loose. Thus, working performance of the user can be improved. In any of the above cases, when the user places the wire reel 9 in the reel loading chamber 94, sets the wire 11 pulled out from the reel 10, and then closes the cover 116, the bearing member 102 engages with the bearing groove 10c of the reel 10 and the bearing groove 10b of the reel 10 engages with the fixed bearing 96, by which the reel 10 is rotatably supported by the fixed bearing 96 and the bearing member 102. After this, even when the engagement portion 11b is disengaged by the wire 11 being pulled out from the reel 10, the loosened wire 11 does not tangle around the rotation axis of the reel 10.

As described above, the wire reel 9 of the present embodiment is used in the rebar tying machine 2, and includes the reel 10 and the wire 11 wound around the reel 10. The wire 11 includes the engagement portion 11b at which the later-wound wire part 11′ is engaged with the earlier-wound part of the wire 11 by the later-wound wire part 11′ sinking below the earlier-wound part of the wire 11. According to this configuration, the later-wound wire part 11′ is prohibited from moving in the direction separating away from the reel 10 since the later-wound wire part 11′ is engaged with the earlier-wound part of the wire 11 at the engagement portion 11b, thus the wire 11 wound around the reel 10 can be prevented from becoming loose. According to this configuration, the wire 11 wound around the reel 10 can be prevented from becoming loose without application of a coating agent on the wire 11.

In the wire reel 9 of the present embodiment, the reel 10 includes the trunk portion 150 around which the wire 11 is wound, and the flange portions 152, 154 provided at both ends of the trunk portion 150. According to this configuration, the flange portions 152, 154 at the both ends restrict movement of the wire 11 wound around the trunk portion 150 in a direction along the trunk portion 150. Thus, when the later-wound wire part 11′ is caused to sink below the earlier-wound part of the wire 11, the later-wound wire part 11′ can surely be engaged with the earlier-wound part of the wire 11.

In the wire reel 9 of the present embodiment, at the engagement portion 11b, the later-wound wire part 11′ is engaged with the earlier-wound part of the wire 11 and the flange portion 152. According to this configuration, the flange portion 152 can be used as a guide when the later-wound wire part 11′ is caused to sink below the earlier-wound part of the wire 11, by which the later-wound wire part 11′ can be easily caused to sink below the earlier-wound part of the wire 11.

In the wire reel 9 of the present embodiment, at least a part of the flange portions 152, 154 is constituted of an elastic material. According to this configuration, the later-wound wire part 11′ can be easily caused to sink below the earlier-wound part of the wire 11 by the flange portions 152, 154 being elastically deformed. Further, according to this configuration, the engagement of the later-wound wire part 11′ with the earlier-wound part of the wire 11 can be maintained by elastic resilience of the flange portions 152, 154. Thus, the wire 11 wound around the reel 10 can be further prevented from becoming loose.

In the wire reel 9 of the present embodiment, the length of the wire 11 from the distal end 11a of the wire 11 to the engagement portion 11b is equal to or greater than a predetermined length, for example, equal to or greater than 80 mm, 270 mm, or 300 mm. In this configuration, by making the length of the wire 11 from the distal end 11a to the engagement portion 11b longer than a length of the wire 11 that the user needs to pull out to set the reel 10 and the wire 11 in the rebar tying machine 2, the wire 11 can be prevented from becoming loose while the user sets the reel 10 and the wire 11 in the rebar tying machine 2.

The manufacturing method of the wire reel 9 of the present embodiment includes steps of: fixing one end of the wire 11 to the reel 10; winding the wire 11 around the reel 10 by feeding the wire 11 while rotating the reel 10; and stopping the feeding of the wire 11 while rotating the reel 10 to cause the later-wound wire part 11′ to sink below the earlier-wound part of the wire 11 such that the later-wound part of the wire 11 is engaged with the earlier-wound wire part 11′. According to the manufacturing method of the present embodiment, the wire 11 is wound around the reel 10 by feeding the wire 11 while rotating the reel 10, and then the feeding of the wire 11 is stopped while rotating the reel 10 to apply a high tensile force on the wire 11. Due to this, the later-wound wire part 11′ is caused to sink below the earlier-wound part of the wire 11 such that the later-wound wire part 11′ can be engaged with the earlier-wound part of the wire 11. According to the manufacturing method of the present embodiment, the wire 11 wound around the reel 10 can be prevented from becoming loose without application of a coating agent on the wire 11.

1. A wire reel for a rebar tying machine, comprising:
a reel; and
a wire wound around the reel,
wherein
the wire comprises an engagement portion, and
at the engagement portion, an earlier-wound part of the wire is engaged with a later-wound part of the wire by the later-wound part of the wire sinking below the earlier-wound part of the wire.

2. The wire reel according to claim 1, wherein
the reel includes:
a trunk portion around which the wire is wound; and
flange portions provided at both ends of the trunk portion, respectively.

3. The wire reel according to claim 2, wherein at the engagement portion, the later-wound part of the wire is engaged with the earlier-wound part of the wire and one of the flange portions.

4. The wire reel according to claim 2, wherein at least a part of the flange portions is constituted of an elastic material.

5. The wire reel according to claim 1, wherein a length of the wire from a distal end of the wire to the engagement portion is equal to or greater than a predetermined length.

6. A method of manufacturing a wire reel for a rebar tying machine, the wire reel including a reel and a wire wound around the reel, the method comprising steps of:
fixing one end of the wire to the reel;
winding the wire around the reel by feeding the wire while rotating the reel; and
stopping the feeding of the wire while rotating the reel to cause a later-wound part of the wire to sink below an earlier-wound part of the wire such that the later-wound part of the wire is engaged with the earlier-wound part of the wire.
